(19) United States
(12) Patent Application Publication
(10) Pub. No.: US 2016/0160803 A1
(43) Pub. Date: Jun. 9, 2016

(54) TWO-PASS AIR-TO-AIR AFTERCOOLER

(71) Applicant: Caterpillar Inc., Peoria, IL (US)

(72) Inventors: Sudhakara Gopireddy, Dunlap, IL (US); James M. Voelker, Metamora, IL (US); Fei Wang, Peoria, IL (US); Neil A. Terry, Edelstein, IL (US)

(73) Assignee: Caterpillar Inc., Peoria, IL (US)

(21) Appl. No.: 14/564,593

(22) Filed: Dec. 9, 2014

(51) Int. Cl. F02M 25/07

(52) U.S. Cl. CPC F02M 25/073; F02M 25/0706

(57) ABSTRACT

An air-to-air aftercooler including a first core assembly configured to receive intake air and cool the intake air. The first core assembly can include a first heat exchange portion configured to cool the intake air, a first inlet configured to receive the intake air, a second heat exchange portion configured to cool the intake air, a second inlet configured to receive the intake air, and a first common tank joining the first heat exchange portion and the second heat exchange portion and configured to output the intake air. The air-to-air aftercooler can also include a second core assembly configured to receive the intake air from the first common tank, and further cool the intake air.

### TECHNICAL FIELD

The present disclosure relates generally to a two-pass air-to-air aftercooler.

### BACKGROUND

In a machine, an air-to-air aftercooler may be used to cool air after it is compressed by a turbocharger. However, they can often be bulky and take up a lot of space. Furthermore, they can also collect dust and particles due to ice or condensation.

U.S. Patent App No. 2013/0264039 filed by Kis et al. ('039 Patent App.) discloses a heat exchanger assembly and method of servicing the same. Some embodiments include a pair of core units in an end-to-end arrangement, and a fluid tank arranged between the core units. Each core unit includes air fins arranged in parallel with one another and spaced apart in a core stacking direction, and fluid conveying tubes arranged in parallel located between and bonded to adjacent air fins. The fluid tank includes a first end sealingly attached to a header plate of one core unit and a second end sealingly attached to a header plate of the other core unit. The fluid tank can be crimped to adjacent core units, and can be located entirely within the core stacking direction outermost boundaries of at least one of the core units.

However, the heat exchanger assembly disclosed in the '039 Patent App. may still take up too much space and be insufficient to solve one or more problems with conventional air-to-air aftercoolers.

The system and method of the present disclosure solves one or more problems set forth above and/or other problems in the art.

### SUMMARY

In one aspect, the present disclosure is directed to an air-to-air aftercooler including a first core assembly configured to receive intake air and cool the intake air. The first core assembly can include a first heat exchange portion configured to cool the intake air, and comprising a first inlet configured to receive the intake air, a second heat exchange portion configured to cool the intake air, and comprising a second inlet configured to receive the intake air, and a first common tank joining the first heat exchange portion and the second heat exchange portion and configured to output the intake air. The air-to-air aftercooler can also include a second core assembly configured to receive the intake air from the first common tank, and further cool the intake air.

In another aspect, the present disclosure is directed to an engine system including a compressor configured to compress intake air, an engine configured to receive the intake air, and an air-to-air aftercooler. The air-to-air aftercooloer can include a first core assembly configured to receive the intake air from the compressor and cool the intake air. The first core assembly can include a first heat exchange portion configured to cool the intake air, and comprising a first inlet configured to receive the intake air from the compressor, a second heat exchange portion configured to cool the intake air, and comprising a second inlet configured to receive the intake air from the compressor, and a first common tank joining the first heat exchange portion and the second heat exchange portion and configured to output the intake air. The air-to-air aftercooler can also include a second core assembly configured to receive the intake air from the first common tank, further cool the intake air, and direct the intake air to the engine. The engine system can also include a fan located upstream from the air-to-air aftercooler, wherein the second core assembly is located upstream of the first core assembly relative to the fan.

In another aspect, the present disclosure is directed to a method for cooling intake air including receiving intake air at a first heat exchange portion and a second heat exchange portion of a first core assembly of an air-to-air aftercooler, cooling the intake air at the first heat exchange portion and the second heat exchange portion, outputting the intake air at a first common tank joining the first heat exchange portion and the second heat exchange portion, receiving the intake air from the first common tank at a second core assembly of the air-to-air aftercooler, and further cooling the intake air using the second core assembly.

### BRIEF DESCRIPTION OF THE DRAWINGS

FIG. 1 is a schematic diagram of a chassis of a machine according to an embodiment;

FIG. 2 depicts a radiator, a fan, and an air-to-air aftercooler according to an embodiment;

FIG. 3 depicts an air-to-air aftercooler according to an embodiment; and

FIG. 4 depicts a first core assembly for an air-to-air aftercooler according to an embodiment;

FIG. 5 depicts a portion of a first core assembly of an air-to-air aftercooler according to an embodiment;

FIG. 6 depicts a portion of a first core assembly and a second core assembly of an air-to-air aftercooler according to an embodiment;

FIG. 7 depicts a plug and seal connection according to an embodiment;

FIG. 8 depicts a portion of a first core assembly of an air-to-air aftercooler according to an embodiment;

FIG. 9 depicts a portion of a first core assembly and a second core assembly of an air-to-air aftercooler according to an embodiment;

FIG. 10 depicts a portion of the first core assembly of an air-to-air aftercooler according to an embodiment;

FIG. 11 depicts a portion of a first core assembly of an air-to-air aftercooler according to an embodiment;

FIG. 12 depicts a portion of a first core assembly and a second core assembly of an air-to-air aftercooler according to an embodiment;

FIG. 13 depicts a portion of the first core assembly of an air-to-air aftercooler according to an embodiment; and

FIG. 14 depicts a process for cooling intake air according to an embodiment.

### DETAILED DESCRIPTION

FIG. 1 depicts a machine 100. The machine 100 may be any type of machine, including construction or earthmoving equipment, electric power generating equipment, locomotive devices, etc. A portion of a chassis 102 of the machine 100 is also shown in FIG. 1 as an outline. An engine 104 may be mounted on the chassis 102. The engine 104 may be any type of internal combustion engine such as, for example, a diesel engine, a gasoline engine, a gaseous fuel powered engine, a heavy fuel engine, or any other type of engine apparent to one skilled in the art.

In the embodiment shown in FIG. 1, the engine 104 is shown with six combustion chambers 106a-106f for generating power. Each of the combustion chambers 106a-106f are provided with a piston, one or more intake valves, one or more exhaust valves, and other components (not shown). The combustion chambers 106a-106f of the engine 104 may be disposed in an “in-line” configuration, a “V” configuration, or another suitable configuration. In some engine configurations there may be separate banks of combustion chambers 106a-106f. For example, in a “V” configuration, there may be two banks of combustion chambers. Alternative arrangements and numbers of combustion chambers 106 would be apparent to one of ordinary skill in the art, and the present embodiment is not limited to those described herein.

The engine 104 may include a turbocharger 108 for compressing intake air 110. The compressed intake air 110 can include, for example, compressed charge air. Due to the heat of compression, the intake air exits turbocharger as heated charge air. The intake air 110 is directed to an air-to-air aftercooler (ATAAC) 112.

Large machines may employ multiple ATAAC modules, to accommodate the volume of intake air 110. The ATAAC 112 cools the intake air 110 prior to entering an air intake manifold 114. In the exemplary embodiment of FIG. 1, one turbocharger is illustrated, but it will be understood that the number of turbochargers could be one or more than one and still fall within the scope of this disclosure. Alternatively, an engine driven supercharger or superchargers may be employed to compress the intake air 110.

The Turbocharger 108 may include a compressor 116, powered by a turbine 118 driven by engine exhaust flow 128. The compressor 116 may pressurize the intake air 110 to allow a greater mass of fuel/air mixture in the engine cylinders of engine 104. The result may be an increase in power and improved engine efficiency. However as a byproduct of pressurization, the temperature of the intake air 110 may also increase, which may be undesirable. As noted above, the intake air 110 may be cooled prior to entering the air intake manifold 114 by passing through the ATAAC 112. Thus, the ATAAC 112 may be provided downstream of the compressor 116 and upstream of the air intake manifold 114 in an engine air induction system 180.

To dissipate the relatively large amount of heat generated directly in the engine 104 by the combustion process in combustion chambers 106a-106f, the engine 104 may be provided with a system of engine coolant passageways 130. The engine coolant passageways 130 may connect, via lines 122 and 124 for example, to a radiator assembly 120. A suitable liquid coolant may circulate within the engine coolant passageways 130, the lines 122 and 124, and the radiator assembly 120, whereby heat from engine 104 may be transferred to the radiator assembly 120. The radiator assembly 120 may be suitably mounted at the front of the machine 100 where dissipation of heat from radiator assembly 120 to ambient air may be facilitated by radiation, conduction, advection, convection, or a combination thereof with or without the aid of a fan 126, such as a motor driven fan, and/or by movement of the machine 100.

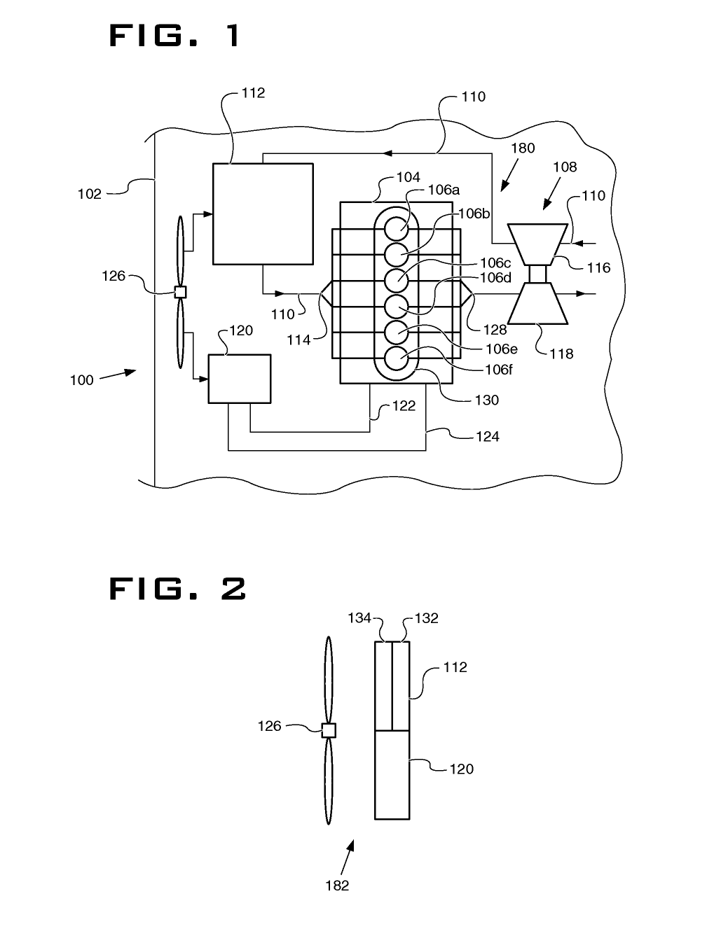

In an embodiment, as shown in FIG. 2, the ATAAC 112 and the radiator assembly 120 may be mounted in the same plane. For example, the embodiment shown in FIG. 2, the ATAAC 112 and the radiator assembly 120 are mounted in a same vertical plane. More specifically, the radiator assembly 120 is located between the ATAAC 112 and a ground. That is, the ATAAC 112 is located above the radiator assembly 120. However, in an embodiment, the ATAAC 112 and the radiator assembly 120 may be serially arranged such that ATAAC 112 is upstream or downstream of the radiator assembly 120. The ATAAC 112 may then be configured to engage a front side or a rear side of the radiator assembly 120.

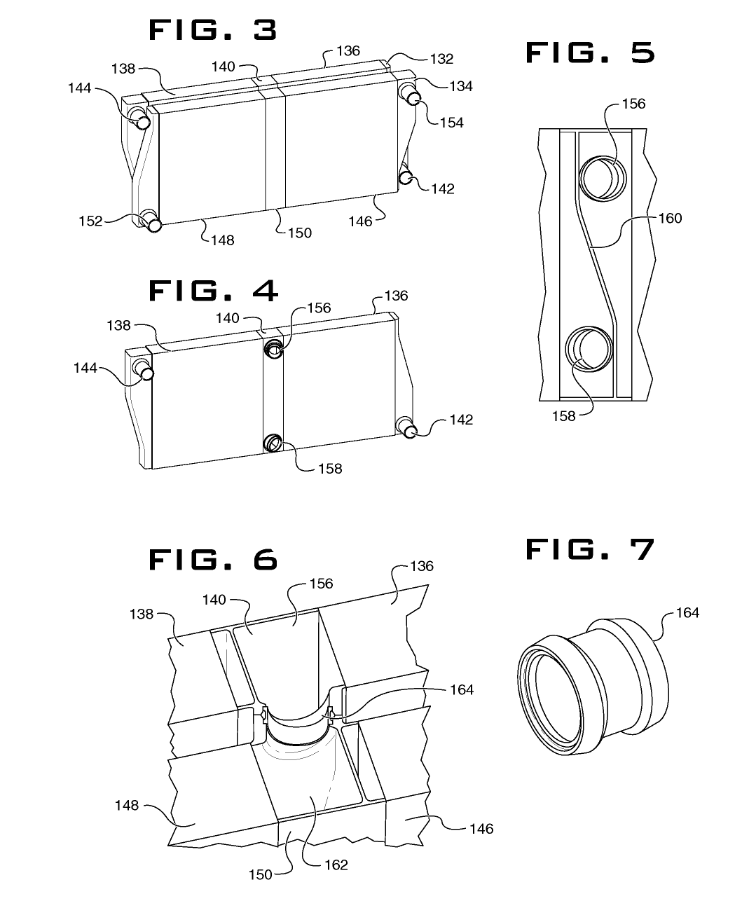

In the embodiment shown in FIG. 2, the ATAAC 112 can comprise a first core assembly 132 and a second core assembly 134. In an embodiment, the ATAAC 112 can be located downstream of the fan 126 in an ambient air cooling system 182. In FIGS. 2 and 3, the second core assembly 134 can be located upstream of the first core assembly 132 with respect to a flow of air coming from the fan 126 in the ambient air cooling system 182.

As shown in FIG. 3, the first core assembly 132 comprises a first heat exchange portion 136, a second heat exchange portion 138, and a first common tank 140 joining the first heat exchange portion and the second heat exchange portion. The first heat exchange portion 136 can comprise a first inlet 142 configured to receive intake air such as the intake air 110 from the compressor 116. Similarly, the second heat exchange portion 138 can comprise a second inlet 144 configured to receive intake air such as the intake air 110 from the compressor 116. In an embodiment such as that shown in FIG. 1, intake air 110 from a single compressor 116 may be split such that it may be delivered to the first inlet 142 and the second inlet 144; alternative embodiments may include configurations having multiple turbochargers 108 and multiple compressors 116 such that each inlet 142, 144 may be directly connected to an individual compressor 116. The first heat exchange portion 136 can comprise tubes and/or fins which run horizontally from the first inlet 142 to the first common tank 140 and which can be configured to cool the intake air 110. Similarly, the second heat exchange portion 138 can comprise tubes and/or fins which run horizontally from the second inlet 144 to the first common tank 140 and which can be configured to cool the intake air 110.

As seen in FIG. 4, the first core assembly 132 also comprises first outlet 156 and a second outlet 158. Thus, the intake air 110 will enter the first inlet 142 and be cooled as it travels horizontally through the tubes and fins into the first common tank 140 and out through the first outlet 156. The first outlet 156 is located diagonally from the first inlet 142. Similarly, the intake air 110 will enter the second inlet 144 and be cooled as it travels horizontally through the tubes and fins into the first common tank 140 and out through the second outlet 158. The second outlet 158 is located diagonally form the second inlet 144. As can be seen in FIG. 5, the first outlet 156 and the second outlet 158 are separated by a plenum 160. The plenum 160 can prevent comingling of the intake air that is output by the first outlet 156 and the second outlet 158. In an embodiment, the second outlet 158 is located in a vertical direction from the first outlet 156.

As seen in FIGS. 3-6, the second core assembly 134 can have a similar or mirrored construction as compared to the first core assembly 132. Thus, some of the description of the second core assembly 134 may be omitted for brevity. For example, the second core assembly 134 can comprise a third heat exchange portion 146 and a fourth heat exchange portion 148 joined by a second common tank 150.

Instead of the first outlet 156 and the second outlet 158, the second core assembly can comprise a third inlet 162 and a fourth inlet (not shown). The third inlet 162 and the fourth inlet (not shown) can be connected to the first outlet 156 and the second outlet 158 respectively. An example of this can be seen in FIGS. 6 and 7. For example, the first outlet 156 is connected to the third inlet 162 by a first plug and seal connection 164. Similarly, the second outlet 158 can be connected to the fourth inlet by a second plug and seal connection (not shown). In an embodiment, the first plug and seal connection 164 can be formed from rubber, steel, aluminum, plastic, elastomer, other flexible material suitable for sealing a gap, or any combination thereof.

In addition, the third inlet 162 and the fourth inlet can also be separated by a plenum similar to that shown in FIG. 5. In an embodiment, the fourth inlet is located in a vertical direction from the third inlet 162.

The intake air 110 can then flow from the third inlet 162 to a third outlet 152. The third inlet 162 is also located diagonally from the third outlet 152. In an embodiment, the third outlet 152 is located horizontally from the first inlet 142, but has approximately a same vertical height as the first inlet 142.

Likewise, the intake air 110 can flow from the fourth inlet (not shown) to a fourth outlet 154. The fourth inlet is also located diagonally from the fourth outlet 154. In an embodiment, the fourth outlet 154 is located horizontally from the second inlet 144, but has approximately a same vertical height as the second inlet 144.

Thus, as can be seen in FIG. 3, one potential difference between the construction of the first core assembly 132 and the second core assembly 134 are the locations of the first inlet 142 and the second inlet 144 in the first core assembly 132, and the locations of the third outlet 152 and the fourth outlet 154 in the second core assembly 134. In addition, in an embodiment, the third outlet 152 and the fourth outlet 154 can face the same direction as the first inlet 142 and the second inlet 144.

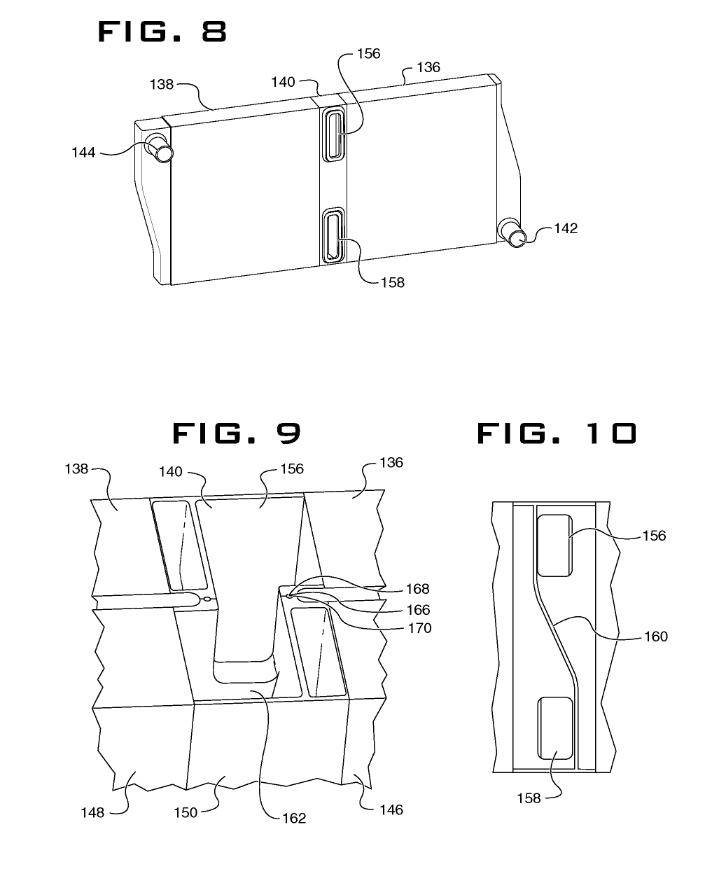

FIGS. 8-10 depict another embodiment of the ATAAC 112. In an embodiment, as shown in FIGS. 8-9, the first outlet 156, the second outlet 158, the third inlet 162, and the fourth inlet can also be formed having a more oblong shape. In addition, the first outlet 156 can be connected to the third inlet 162 using a press in place seal connection 166. That is, the first outlet 156 can define a gap 168, and the third inlet 162 can define a gap 170.

The press in place seal connection 166 can be located in the gaps 168 and 170 to form a seal around the first outlet 156 and the third inlet 162. In an embodiment, press in place seal connection 166 can comprise an O-ring. The press in place seal connection 166 can also be formed, for example, from rubber, steel, aluminum, plastic, elastomer, other flexible material suitable for sealing a gap, or any combination thereof. Furthermore, the second outlet 158 and the fourth inlet can also be connected by a press in place seal connection in a similar fashion.

As seen in FIG. 10, the first outlet 156 and the second outlet 158 are still separated by the plenum 160 as shown in FIG. 10. Thus, the third inlet 162 and the fourth inlet can also be separated by a plenum (not shown).

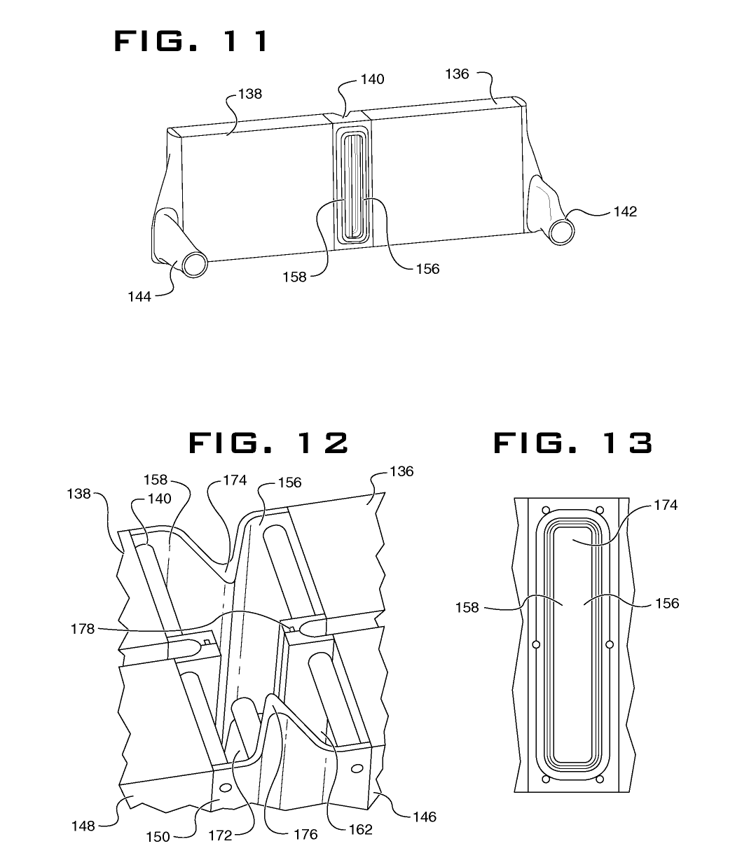

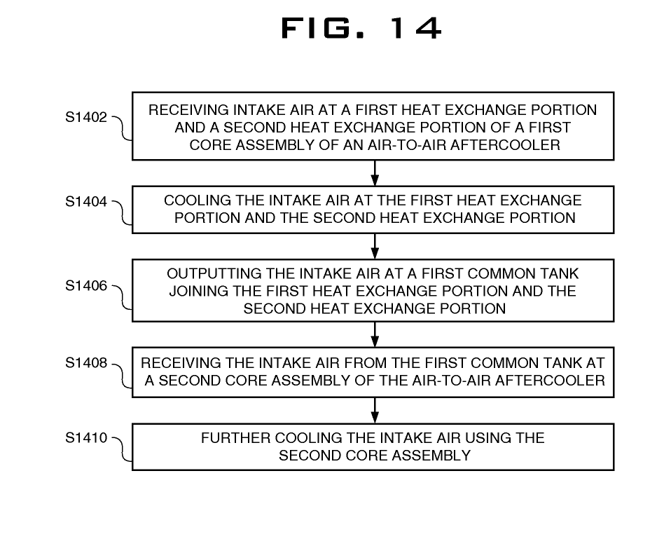

FIGS. 11-13 depict another embodiment of the ATAAC 112. As shown in FIG. 11, the first outlet 156 and the second outlet 158 now extend vertically and are located adjacent each other. As shown in FIGS. 12 and 13, the first outlet and the second outlet 158 are separated by a ridge 174 instead of a plenum Likewise, the third inlet 162 and the fourth inlet 172 now extend vertically and are located adjacent each other. The third inlet 162 and the fourth inlet 172 are defined by a ridge 176, and this embodiment lacks a fully formed plenum as in the previous embodiments. The ridges may not prevent comingling of the intake air 110. Thus, the third inlet 162 can be connected to the first outlet 156 and the second outlet 158. Likewise, the fourth inlet 172 can also be connected to the first outlet 156 and the second outlet 158.

The first common tank 140 and the second common tank 150 can be connected using a seal connection 178. In an embodiment, the seal connection can comprise for example, a plug and seal connection or a press in place seal connection.

### INDUSTRIAL APPLICABILITY

In an embodiment, a process for cooling the intake air 110 is shown in FIG. 14. In block S1402, the intake air 110 is received at the first heat exchange portion 136 and the second heat exchange portion 138 of the first core assembly 132 of the ATAAC 112. In block S1404, the first heat exchange portion 136 and the second heat exchange portion 138 cool the intake air 110. In block S1406, the intake air 110 is then output from the first common tank 140. The first common tank 140 can join the first heat exchange portion 136 and the second heat exchange portion 138.

In block S1408, the second core assembly 134 receives the intake air 110 from the first common tank 140. In block S 1410, the intake air 110 is further cooled using the second core assembly 134.

Thus, in the ATAAC 112, the intake air 110 is first cooled using the first core assembly 132 instead of the second core assembly 134 even though the second core assembly 134 is upstream of the first core assembly 132 relative to the fan 126 (FIG. 2). This can ensure that the intake air 110 will be cooled in a two pass manner. For example, initially the air from the fan will be cool and have a first temperature. After passing through the second core assembly 134, the air from the fan will be warmed and have a second temperature higher than the first temperature. However, the second temperature will still be cooler than the intake air 110 when it passes through the first core assembly 132. Thus, the intake air 110 will be cooled when it passes through the first core assembly 132. This two-pass methodology promotes cooling efficiency across the ATAAC 112 since the differential temperature between the cooling fluid flow and the fluid to be cooled is optimized across the entire surface area of the ATAAC 112.

As the intake air 110 is cooled, it will proceed to the second core assembly 134. As previously noted, the second core assembly 134 is upstream of the first core assembly 132 relative to the fan 126. Thus, the intake air 110 will still be cooled by the air from the fan since the air from the fan will be at the first temperature, which is cooler than the second temperature.

In an embodiment, using the first common tank 140 and the second common tank 150 can reduce a horizontal distance that the air has to travel. This can decrease a distance that the intake air 110 has to travel in a horizontal direction and promote even distribution of the intake air 110 across the various tubes in the heat exchange portions. Similarly, in FIGS. 3-7 and 8-10, locating the inlets and outlets diagonally from each other can also promote even distribution of the intake air 110 across the various tubes in the heat exchange portions. This can improve an efficiency of the ATAAC 112 since even distribution of the intake air 110 can lead to better cooling performance. That is, in some instances, the size of the ATAAC 112 may be reduced to achieve the same amount of cooling as an ATAAC 112 with a less even distribution of the intake air 110.

With respect to the embodiment shown in FIGS. 11-13, the first common tank 140 and the second common tank 150 can promote mixing of the intake air 110 to produce a more uniform temperature. The ridges 174 and 176 can be utilized to direct the intake air 110 from the first common tank 140 to the second common tank 150 without the intake air 110 colliding with each other and reducing movement of the intake air 110. For example, the ridge 174 can prevent the intake air 110 in the first heat exchange portion 136 from directly colliding with the intake air 110 from the second heat exchange portion 138.

In an embodiment, by locating the ATAAC 112 above the radiator assembly 120, the ATAAC 112 can have a reduced buildup of dust and particulates. For example, by locating the ATAAC 112 above the radiator assembly 120, there is a reduced likelihood that ice or condensation will form on the ATAAC 112. Since dust or particulates may adhere to ice or condensation, this can reduce the amount of dust or particulates that will build up on the ATAAC 112. This can improve an efficiency of the ATAAC 112 since dust or particulate build up can reduce the ability of the ATAAC 112 to cool the intake air 110.

With respect to the embodiment shown in FIGS. 3-7, the use of the plug and seal connection 164 can allow misalignment between the first core assembly 132 and the second core assembly 134. This can reduce manufacturing costs, installation costs, and/or operation costs.

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims.

What is claimed is:

1. An air-to-air aftercooler comprising:
a first core assembly configured to receive intake air and cool the intake air, the first core assembly comprising:
a first heat exchange portion configured to cool the intake air, and comprising a first inlet configured to receive the intake air,
a second heat exchange portion configured to cool the intake air, and comprising a second inlet configured to receive the intake air, and
a first common tank joining the first heat exchange portion and the second heat exchange portion and configured to output the intake air; and
a second core assembly configured to receive the intake air from the first common tank, and further cool the intake air.

2. The air-to-air aftercooler of claim 1 wherein the first common tank further comprises:
a first outlet located diagonally from the first inlet and configured to receive the intake air from the first inlet, and
a second outlet located diagonally from the second inlet and in a vertical direction from the first outlet, and configured to receive the intake air from the second inlet.

3. The air-to-air aftercooler of claim 2 wherein the first common tank further comprises a plenum separating the first outlet and the second outlet.

4. The air-to-air aftercooler of claim 2 wherein the second core assembly further comprises a second common tank configured to be connected to the first common tank.

5. The air-to-air aftercooler of claim 4 wherein the second common tank further comprises:
a third inlet configured to be connected to the first outlet by a first plug and seal connection, and
a fourth inlet located in a vertical direction from the third inlet and configured to be connected to the second outlet by a second plug and seal connection.

6. The air-to-air aftercooler of claim 4 wherein the second common tank further comprises:
a third inlet configured to be connected to the first outlet by a first press in place seal connection, and
a fourth inlet located in a vertical direction from the third inlet and configured to be connected to the second outlet by a second press in place seal connection.

7. The air-to-air aftercooler of claim 1 wherein the first common tank further comprises:
a first outlet extending in a vertical direction and configured to receive the intake air from the first inlet, and
a second outlet extending in the vertical direction, located adjacent to the first outlet in a horizontal direction, and separated from the first outlet by a first ridge, the second outlet configured to receive the intake air from the second inlet.

8. The air-to-air aftercooler of claim 7 wherein the second core assembly further comprises a second common tank configured to be connected to the first common tank.

9. The air-to-air aftercooler of claim 8 wherein the second common tank further comprises:
a third inlet extending in the vertical direction and configured to be connected to the first outlet and the second outlet, and
a fourth inlet extending in the vertical direction, located adjacent the third inlet in the horizontal direction, and separated from the third inlet by a second ridge, the fourth inlet configured to be connected to the first outlet and the second outlet.

10. An engine system comprising:
a compressor configured to compress intake air;
an engine configured to receive the intake air;
an air-to-air aftercooler comprising:
a first core assembly configured to receive the intake air from the compressor and cool the intake air, the first core assembly comprising:
a first heat exchange portion configured to cool the intake air, and comprising a first inlet configured to receive the intake air from the compressor,
a second heat exchange portion configured to cool the intake air, and comprising a second inlet configured to receive the intake air from the compressor, and
a first common tank joining the first heat exchange portion and the second heat exchange portion and configured to output the intake air; and
a second core assembly configured to receive the intake air from the first common tank, further cool the intake air, and direct the intake air to the engine; and
a fan located upstream from the air-to-air aftercooler, wherein the second core assembly is located upstream of the first core assembly relative to the fan.

11. The engine system of claim 10 wherein the first common tank further comprises:
a first outlet located diagonally from the first inlet and configured to receive the intake air from the first inlet,
a second outlet located diagonally from the second inlet and in a vertical direction from the first outlet, and configured to receive the intake air from the second inlet, and
a plenum separating the first outlet and the second outlet.

12. The engine system of claim 11 wherein the second core assembly further comprises a second common tank configured to be connected to the first common tank.

13. The engine system of claim 12 wherein the second common tank further comprises:
a third inlet configured to be connected to the first outlet by a first plug and seal connection, and
a fourth inlet located in a vertical direction from the third inlet and configured to be connected to the second outlet by a second plug and seal connection.

14. The engine system of claim 12 wherein the second common tank further comprises:
a third inlet configured to be connected to the first outlet by a first press in place seal connection, and
a fourth inlet located in a vertical direction from the third inlet and configured to be connected to the second outlet by a second press in place seal connection.

15. The engine system of claim 10 wherein the first common tank further comprises:
a first outlet extending in a vertical direction and configured to receive the intake air from the first inlet, and
a second outlet extending in the vertical direction, located adjacent to the first outlet in a horizontal direction, and separated from the first outlet by a first ridge, the second outlet configured to receive the intake air from the second inlet.

16. The engine system of claim 15 wherein the second core assembly further comprises a second common tank configured to be connected to the first common tank.

17. The engine system of claim 16 wherein the second common tank further comprises:
a third inlet extending in the vertical direction and configured to be connected to the first outlet and the second outlet, and
a fourth inlet extending in the vertical direction, located adjacent the third inlet in the horizontal direction, and separated from the third inlet by a second ridge, the fourth inlet configured to be connected to the first outlet and the second outlet.

18. A method for cooling intake air comprising:
receiving intake air at a first heat exchange portion and a second heat exchange portion of a first core assembly of an air-to-air aftercooler;
cooling the intake air at the first heat exchange portion and the second heat exchange portion;
outputting the intake air at a first common tank joining the first heat exchange portion and the second heat exchange portion;
receiving the intake air from the first common tank at a second core assembly of the air-to-air aftercooler; and
further cooling the intake air using the second core assembly.

19. The method of claim 18 further comprising receiving the intake air at the first heat exchange portion and the second heat exchange portion from a compressor.

20. The method of claim 19 further comprising outputting the intake air from the second core assembly to an engine.
